(19) United States
(12) Patent Application Publication
(10) Pub. No.: US 2023/0232502 A1
(43) Pub. Date: Jul. 20, 2023

(54) HEATER AND AEROSOL-GENERATION DEVICE

(71) Applicant: SHENZHEN FIRST UNION TECHNOLOGY CO., LTD., Shenzhen City, Guangdong Province (CN)

(72) Inventors: ZUQIANG QI, Shenzhen City, Guangdong Province (CN); JIAMAO LUO, Shenzhen City, Guangdong Province (CN); BAOLING LEI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/007,739

(22) PCT Filed: Jun. 1, 2021
(86) PCT No.: PCT/CN2021/097752

§ 371 Date: Dec. 1, 2022

(30) Foreign Application Priority Data
Jun. 1, 2020 (CN) 202010483185.1

(51) Int. Cl. H05B 3/14; A24F 40/46

(52) U.S. Cl. CPC H05B 3/141; A24F 40/46; H05B 2203/013; H05B 2203/017

(57) ABSTRACT

A heater includes a base body; an infrared electric heating film, formed on a surface of the base body, the infrared electric heating film including doped tin oxide and doping elements of the doped tin oxide including non-metal elements; and the infrared electric heating film being configured to generate infrared ray and heat the aerosol-forming substrate at least in a radiation manner; and a conductive portion, including a first electrode and a second electrode arranged on the base body, and both the first electrode and the second electrode being electrically connected to the infrared electric heating film to feed electric power of a power supply to the infrared electric heating film. An infrared electric heating film including doped tin oxide is formed on a base body, and doping elements of the doped tin oxide facilitate to improve conductive performance and infrared radiation efficiency of the infrared electric heating film.

### CROSS-REFERENCE TO RELATED APPLICATIONS

This application claims priority to Chinese Patent Application No. 202010483185.1, entitled “HEATER AND AEROSOL-GENERATION DEVICE” filed with the China National Intellectual Property Administration on Jun. 1, 2020, which is incorporated herein by reference in its entirety.

### TECHNICAL FIELD

This application relates to the field of cigarette device technologies, and in particular, to a heater and an aerosol-generation device.

### BACKGROUND

During use of smoking objects such as a cigarette or cigar, tobaccos are burnt to generate vapor. A product that releases compounds without burning has been tried to provide an alternative for the objects that burn tobaccos. An example of the products is a heat-not-burn product, which releases compounds by heating tobaccos rather than burning tobaccos.

An existing heat-not-burn cigarette device mainly generates heat through a heating body and conducts the heat to an aerosol-generation substrate in a chamber, so that at least one component of the aerosol-generation substrate generates aerosols through volatilization for inhalation by a user. This heating manner has a high temperature rising speed but has a low heat conduction efficiency, preheating of the aerosol-generation substrate is slow, and the inside of the material of the base body cannot be effectively heated. As a result, a taste of the aerosols is poor and the experience is not good.

### SUMMARY

This application provides a heater and an aerosol-generation device, to resolve the problems of insufficient penetrability and non-uniform heating when an existing cigarette device heats an aerosol-generation substrate.

According to an aspect of this application, a heater is provided, configured to heat an aerosol-forming substrate to volatilize at least one component in the aerosol-forming substrate, and the heater including:

a base body;

an infrared electric heating film, formed on a surface of the base body, the infrared electric heating film comprising doped tin oxide and doping elements of the doped tin oxide comprising non-metal elements; and the infrared electric heating film being configured to generate infrared ray and heat the aerosol-forming substrate at least in a radiation manner; and

a conductive portion, comprising a first electrode and a second electrode arranged on the base body, and both the first electrode and the second electrode being electrically connected to the infrared electric heating film to feed electric power of a power supply to the infrared electric heating film.

According to another aspect of this application, an aerosol-generation device is further provided, including a housing assembly and the heater, where the heater is arranged in the housing assembly.

According to the heater and the aerosol-generation device provided in this application, an infrared electric heating film including doped tin oxide is formed on a base body, and doping elements of the doped tin oxide facilitate to improve the conductive performance and the infrared radiation efficiency of the infrared electric heating film. When an aerosol-forming substrate is heated by the infrared electric heating film through radiation, the aerosol-forming substrate has a high center temperature and a short preheat time and is uniformly heated.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of a heater according to an implementation of this application;

FIG. 2 is a schematic SEM diagram of an infrared electric heating film formed through a preparation process according to an implementation of this application;

FIG. 3 is a schematic XPS diagram of an infrared electric heating film formed through a preparation process according to an implementation of this application;

FIG. 4 is a schematic diagram of temperature curves of infrared radiation heating and non-infrared radiation heating according to an implementation of this application;

FIG. 5 is another schematic diagram of temperature curves of infrared radiation heating and non-infrared radiation heating according to an implementation of this application;

FIG. 6 is a schematic XPS diagram of an infrared electric heating film formed through another preparation process according to an implementation of this application;

FIG. 7 is a schematic diagram of an aerosol-generation device according to an implementation of this application; and

FIG. 8 is a schematic exploded view of an aerosol-generation device according to an implementation of this application.

### DETAILED DESCRIPTION

For ease of understanding of this application, this application is described below in more detail with reference to accompanying drawings and specific implementations. It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

Implementation 1:

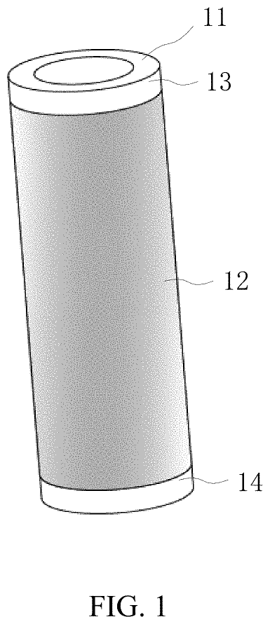

Referring to FIG. 1, Implementation 1 of this application provides a heater configured to heat an aerosol-forming substrate through infrared radiation and volatilize at least one component in the aerosol-forming substrate to form aerosols for inhalation by a user. The heater 1 includes a base body 11, an infrared electric heating film 12, and conductive portions (13 and 14).

A space for accommodating the aerosol-forming substrate is formed inside the base body 11, and an inner surface of the base body 11 forms at least a partial boundary of the space. The base body 11 includes a first end and a second end opposite to each other, and the base body 11 extends in a longitudinal direction between the first end and the second end and is hollow inside to form a chamber adapted to accommodate the aerosol-forming substrate. The base body 11 may be in a shape of a cylinder, a prism, or another column. Preferably, the base body 11 is in a shape of cylinder, and the chamber is a cylindrical hole running through a middle part of the base body 11, where an inner diameter of the hole is slightly greater than an outer diameter of an aerosol-forming article or a smoking article, so that the aerosol-forming article or the smoking article may be placed in the chamber for heating.

The base body 11 may be formed by selecting a material that is high-temperature resistant and has a relatively high infrared ray transmittance, and the material of the base body 11 is selected from at least one of the following: monocrystalline germanium, monocrystalline silicon, gallium arsenide, gallium phosphide, sapphire, polycrystalline aluminum oxide, spinel, magnesium oxide, yttrium(III) oxide, quartz, yttrium aluminum garnet, zinc sulphur, zinc selenide, silicon carbide, silicon nitride, magnesium fluoride, calcium fluoride, or arsenic trisulfide. Preferably, the material of the base body 11 is quartz.

The aerosol-forming substrate is a substrate that can release volatile compounds forming aerosols. The volatile compounds may be released by heating the aerosol-forming substrate. The aerosol-forming substrate may be solid, liquid, or include solid and liquid components. The aerosol-forming substrate may be carried on a carrier or a support through absorption, coating, impregnation, or other manners. The aerosol-forming substrate may conveniently be a part of the aerosol-forming article or the smoking article.

The aerosol-forming substrate may include nicotine. The aerosol-forming substrate may include tobaccos, for example, may include a tobacco-contained material including volatile tobacco-flavor compounds, and the volatile tobacco-flavor compounds are released from the aerosol-forming substrate when the aerosol-forming substrate is heated. Preferably, the aerosol-forming substrate may include a homogeneous tobacco material such as leaf tobaccos. The aerosol-forming substrate may include at least one aerosol forming agent, and the aerosol forming agent may be any suitable known compound or a mixture of compounds. During use, the compound or the mixture of compounds facilitates to stabilize formation of aerosols and is basically resistant to thermal decomposition under an operating temperature of an aerosol-generation system. A suitable aerosol forming agent is well known in the art, which includes, but not limited to: polyol, such as triethylene glycol, 1,3-butanediol, and glycerin; polyol ester, such as monoglyceride and diacetate or triacetate; and monobasic carboxylic acid, dibasic carboxylic acid, and polybasic carboxylic acid fatty acid ester, such as dimethyl dodecane dibasic ester and dimethyl tetradecane dibasic ester. Preferably, the aerosol forming agent is polyhydric ester or a mixture thereof, such as triethylene glycol, 1,3-butanediol, or most preferably, glycerol.

The infrared electric heating film 12 is formed on the base body 11 and includes doped tin oxide. The infrared electric heating film 12 may be formed on an outer surface of the base body 11, or may be formed on an inner surface of the base body 11. Preferably, the infrared electric heating film 12 is formed on the outer surface of the base body 11.

SnO₂ is a very important wide bandgap (a bandgap width ranges from 3.7 eV to 4.3 eV) metallic oxide semiconductor material. Common monocrystalline SnO₂ is of a tetragonal rutile structure. In a unit cell of tin oxide, a Sn atom is located at a center position of an oxygen octahedron, and each Sn atom has 6 O atoms around; and similar, each 0 atom is connected to 3 Sn atoms. A polycrystalline SnO₂ thin film is formed by crystalline grains of a tetragonal cassiterite structure or a tetragonal rutile structure. A preferred orientation of the crystalline grains of a SnO₂ thin film prepared by a thin film process is closely related to parameters such as a crystal place structure, a surface state, and a growth temperature of a base body material.

The doped tin oxide generally includes n-type doped and p-type doped.

P-type doped refers to doping ions with the valence of +3 to the SnO₂ thin film to replace a position of the Sn atom in the lattice and providing 1 hole for a valence band. A trapping capability of the doped ions to the hole is relatively weak, so that the hole may become a conductive hole freely moving in a crystal, so as to realize p-type doped semiconductor.

Electrical resistivity control of p-type doped is not stable, so that n-type doped SnO₂ thin films are common, such as stibium-doped tin oxide (SnO₂:Sb, referred to as ATO) and fluorine-doped tin oxide (SnO₂:F, referred to as FTO).

In the ATO, 5 valence electrons exist outside a Sb atom nucleus to replace Sn atoms with the valence of +4 in the lattice. Each Sb atom may provide 1 free electron, and the SnO₂ thin film becomes an n-type semiconductor with conductive electrons after Sb is doped.

In the FTO, 7 valence electrons exist outside an F atom nucleus. Different from common replacement with positive ions, in F-doped SnO₂, O²⁻ is replaced by a negative ion F⁻ or an F atom is located at a gap position of a lattice atom to form a gap-doped atom. An atom radius of F is 0.71 nm, an atom radius of O is 0.74 nm, atom radii and structures of valence electron layers thereof are similar, and bond energy of O—SN is less than bond energy of F—SN, so that F can replace O in the SnO₂ lattice easily. The SnO₂ belongs to an ionic crystal, and an F atom has one more valence electron than an O atom, so that when the F atom obtains one electron less than the O atom, a structure with saturated electrons on an outer layer can be reached. Therefore, one of the valence electrons provided by Sn is left, so that Sn becomes positively charged center Sn⁺, the Sn+ positively charged center releases out the extra electron, and the extra electron becomes a conductive electron and can move freely.

In this implementation, the doping elements of the doped tin oxide include non-metal elements.

In an example, the doping elements include phosphorus, and an atomic percentage of the phosphorus ranges from 5% to 9%, preferably ranges from 5% to 8.7%, and more preferably ranges from 6% to 8.7%.

Under suitable doping concentration, a SnO₂:P thin film is a polycrystalline degenerate semiconductor, and a P atom generally serves as a donor atom with the valence of five in the SnO₂ lattice. The electrical conductivity increases as the concentration of the P atom increases, and when the concentration of the P atom reaches a value, the electrical conductivity decreases as the concentration of the P atom increases. When the P atom is first doped, the P atom serves as a donor atom to cause the concentration of carriers to increase, so that the electrical conductivity of the SnO₂:P increases; and when a specific value is reached, after the concentration of the P atom is further increased, the concentration of ionization impurities and the defect concentration of the lattice increase, and the carrier mobility decreases, so that the electrical conductivity decreases.

Further, the doping elements further include carbon, and an atomic percentage of the carbon ranges from 4% to 15%, preferably ranges from 4% to 14.7%, and more preferably ranges from 4.5% to 14.7%.

Further, the doping elements further include calcium, and an atomic percentage of the calcium ranges from 1% to 2%, preferably ranges from 1.2% to 1.8%, more preferably ranges from 1.2% to 1.6%, and further preferably is 1.4%.

In this implementation, a thickness of the infrared electric heating film 12 ranges from 100 nm to 30 μm, preferably ranges from 300 nm to 3 μm, more preferably ranges from 500 nm to 2 μm, and further preferably ranges from 800 nm to 1 μm,

In this implementation, a sheet resistance (Ω/puff) of the infrared electric heating film 12 ranges from 0.3 to 35, preferably ranges from 1 to 30, more preferably ranges from 1 to 18, further preferably ranges from 1 to 14, further preferably ranges from 1 to 10, further preferably ranges from 1.5 to 10, further preferably ranges from 2 to 10, further preferably ranges from 3 to 10, and further preferably ranges from 3.5 to 10.

The following further describes this implementation in combination with specific preparation processes of the infrared electric heating film 12.

### Embodiment 1

The infrared electric heating film 12 is prepared on the base body 11 (a quartz tube) through magnetron sputtering by doping element P and element C in tin oxide. An inner diameter of the quartz tube is 7.2 mm, an outer diameter thereof is 9.2 mm, and a height thereof is 29 mm.

Specifically, a magnetron sputtering coating device is a magnetron sputtering coating device with an anode ion source, where an anode voltage of the anode ion source is 1500 V, and an anode current thereof is 0.3 A; and a magnetron sputtering power supply adopts a 3 kW bipolar pulse direct-current power supply.

On one hand, the anode ion source may generate high-energy plasma to perform etching plasma cleaning on a surface of a workpiece, to ensure molecule-level cleaning on the surface of the workpiece and lay the foundation for good film-base combination performance. On the other hand, the anode ion source may cause gas such as methane, acetylene, NH₃, and PH₃ to be decomposed, and elements such as carbon, nitrogen, and phosphorus are deposited on the surface of the workpiece or may be deposited together with other targets to dope components forming a film.

The bipolar pulse direct-current power supply may perform sputtering on a metal target or may perform sputtering on a semiconductor material such as a silicon target, a tin oxide target, an ATO target, or an indium tin oxide target. A bipolar pulse direct-current output may perform output through a positive-negative voltage commutating pole in a manner of pulse, where a pulse form may be positive pulse, negative (commutating) pulse, ratio pulse, gap pulse, counting pulse, timing pulse, or program pulse. By using the bipolar pulse direct-current power supply, charges may be prevented from accumulating on the surface of the target to cause sparking on the surface of the target, which affects the quality of the film formed on the surface. By using the bipolar pulse direct-current power supply, sputtering may be directly performed on a metal oxide target with common conductive performance, and compared with performing sputtering through a radio frequency power supply (RF power supply with 13.56 MHz), the RF power supply causes radiation damage to a human body.

The magnetron sputtering coating device is further provided with a workpiece rest revolution and autorotation system, so that a plurality of samples may be prepared at a time. The workpiece rest revolution and autorotation system may ensure the uniformity of film coating on a cylindrical surface of the quartz tube, so that resistance is distributed uniformly and heat is generated uniformly. A preparation process is shown as follows:

The quartz tube is first loaded on a base body frame, a door of a vacuum chamber is closed and the vacuum chamber is vacuumized to be lower than 5×10⁻³ Pa. Argon with a flow of 100 sccm is introduced into the vacuum chamber to keep the pressure of the vacuum chamber around 3×10⁻¹ Pa.

The anode ion source is then started, a voltage is set to 1500 V and a current is about 0.3 A, output is performed in a constant voltage mode to cause ionization of the argon to generate Ar⁺ plasma impacted on the surface of the workpiece, to clean the surface of the workpiece rest, where the impact lasts for 15 minutes.

The flow of the argon is then set to 40 sccm, a PH3 has quality flow counter is started and a flow is set to 15 sccm, and an acetylene gas quality flow counter is started and a flow is set to 5 sccm. The anode ion source and the tin oxide target bipolar pulse direct-current power supply are started simultaneously, the voltage of the anode ion source is set to 1500 V and the current thereof is set to 0.3 A, a voltage of the bipolar pulse direct-current power supply is set to 600 V and a current thereof is set to 5 A, and a voltage of negative pulse is set to 200 V, a current is set to 2.5 A, and a duty cycle is set to 20%. By starting the anode ion source and the bipolar pulse direct-current power supply simultaneously, ionization rates of the doped gas PH₃ and the acetylene may be improved, to improve the atomic percentage of the doped atoms in the thin film, thereby improving the electrical conductivity of a doped tin oxide film.

Finally, a thickness of a thin infrared electric heating film 12 obtained through deposition for 30 minutes is about 1 μm, and a sheet resistance (Ω/puff) thereof is about 7. After a conductive coating (electrode) is formed on the infrared electric heating film 12, an entire resistance value of the infrared electric heating film 12 is about 2Ω.

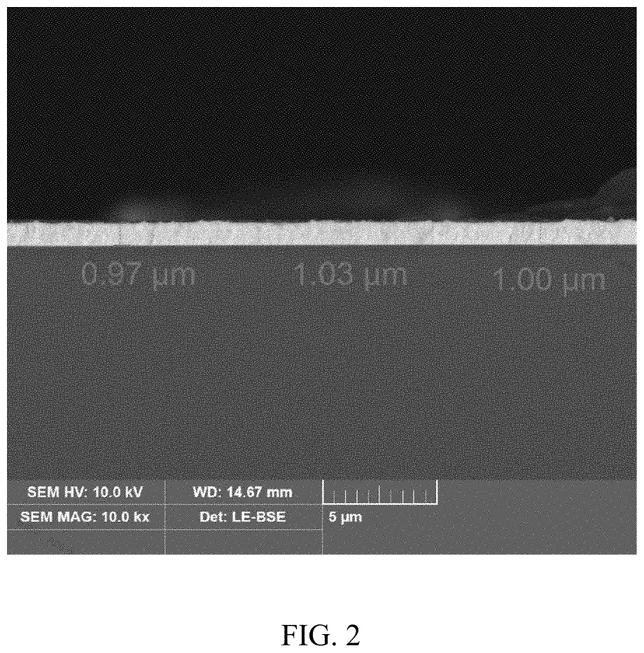

FIG. 2 is a schematic SEM diagram of the infrared electric heating film 12 prepared through Embodiment 1. As can be seen from the figure, the thickness of the thin infrared electric heating film 12 is uniform and an average thickness thereof is 1 μm.

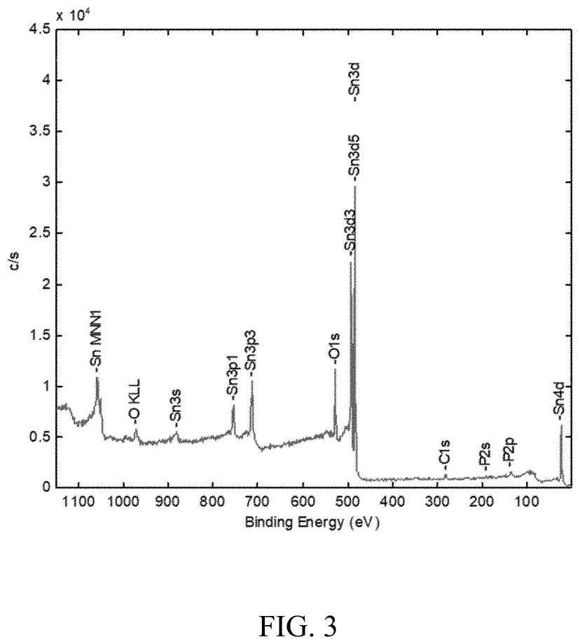

FIG. 3 is a schematic XPS diagram of the infrared electric heating film 12 prepared through Embodiment 1, and percentages by atom numbers of specific components are shown in the following table.

| | Percentage by |
|---|---|
| Element | atom number (%) |
| Sn | 51.1 |
| O | 38.4 |
| P | 6.0 |
| C | 4.5 |

By doping element P and element C in the tin oxide, the conductive performance and the infrared radiation efficiency of the tin oxide thin film may be improved.

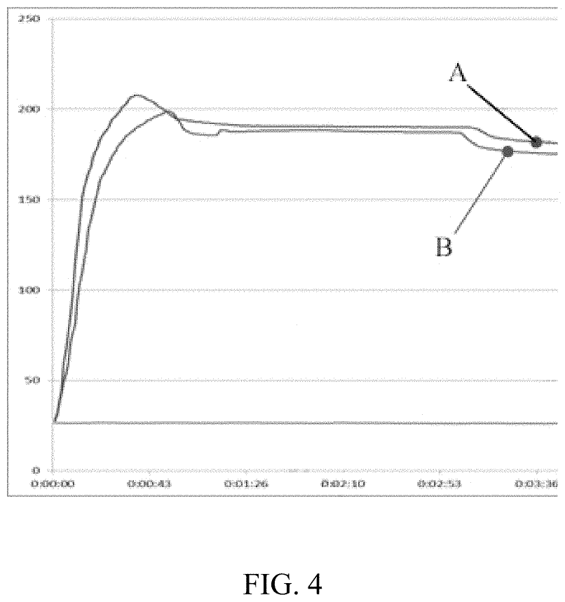

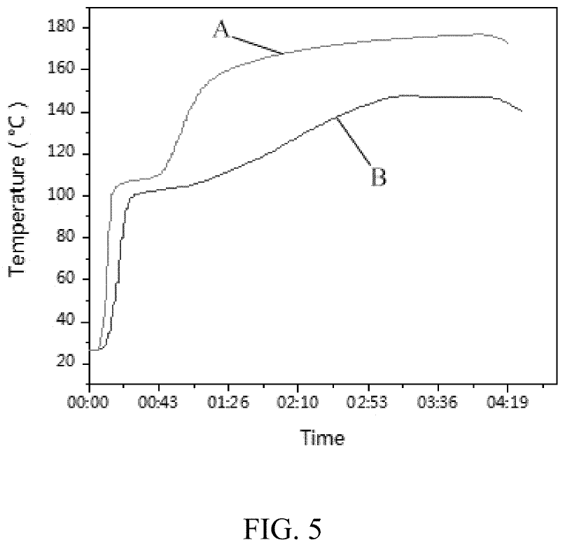

Specifically, referring to FIG. 4 and FIG. 5, in FIG. 4 and FIG. 5, A is a temperature curve when the infrared electric heating film 12 prepared through Embodiment 1 heats the aerosol-forming substrate through infrared radiation, and B is a temperature curve when a cigarette device heats the aerosol-forming substrate without infrared radiation. A temperature of the aerosol-forming substrate is measured by inserting a thermocouple into a center position of a cigarette. As can be seen from the figure, when the infrared electric heating film 12 prepared through Embodiment 1 heats the aerosol-forming substrate through infrared radiation, the temperature of the center position of the cigarette is apparently higher than the temperature of the curve B, namely, the infrared electric heating film has a specific penetration depth and heating is performed more uniformly. In addition, a preheat time of the curve A is shorter than that of the curve B, thereby shortening a waiting time of the user.

### Embodiment 2

The infrared electric heating film 12 is prepared on the base body 11 (a quartz tube) through chemical vapor deposition by doping element P, element C, and element Ca in tin oxide. An inner diameter of the quartz tube is 7.2 mm, an outer diameter thereof is 9.2 mm, and a height thereof is 29 mm.

A preparation process is shown as follows:

SnCl₄·5H₂O, concentrated H₃PO₄, isopropanol, and a small amount of CaCl₂) solution are used as raw materials, and water is used as a solution, to prepare a mixed solution in which a concentration of SnCl₄ is 1 mol/L, a concentration of H₃PO₄ is 0.2 mol/L, a concentration of isopropanol is 0.15 mol/L, and a concentration of the CaCl₂) solution is 0.03 mol/L. The mixed solution is heated to 400° C. to 700° C., and typically, heated to 600° C. The mixed solution forms vaporized smoke under a high temperature.

A temperature of the base body 11 is heated to 300° C. to 600° C., and typically, heated to 500° C.

Ar and O₂ are used as carrier gas and flows of the introduced Ar and O₂ are both 50 sccm. The carrier gas carries the vaporized smoke formed by the mixed solution to flow to a direction of a workpiece with a relatively low temperature. The vaporized smoke formed by the mixed solution reacts with O₂ in the carrier gas to form the infrared electric heating film 12 on the surface of the quartz tube workpiece. A thickness of the obtained thin infrared electric heating film 12 is about 1 μm, and a sheet resistance (2/puff) thereof is about 3.5. After a conductive coating (for example, a silver electrode) is formed on the infrared electric heating film 12, an entire resistance value of the infrared electric heating film 12 is about 1Ω.

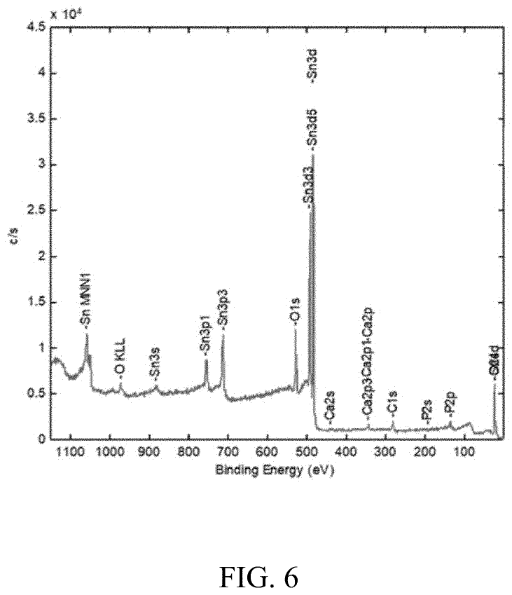

FIG. 6 is a schematic XPS diagram of the infrared electric heating film 12 prepared through this embodiment, and percentages by atom numbers of specific components are shown in the following table.

| | Percentage by |
|---|---|
| Element | atom number (%) |
| Sn | 42.6 |
| O | 32.6 |
| C | 14.7 |
| P | 8.7 |
| Ca | 1.4 |

By doping element P, element C, and element Ca in the tin oxide, the conductive performance and the infrared radiation efficiency of the tin oxide thin film may also be improved.

It should be noted that, in the foregoing embodiment or described content, components in the infrared electric heating film 12 are not limited to the doped tin oxide, and may further include other materials such as tin(IV) chloride, tin oxide, antimonous chloride, titanium (IV) chloride, far infrared electric heating ink, and ceramic powder.

It should be further noted that, the infrared electric heating film 12 is formed on the surface of the base body 11 through physical vapor deposition or chemical vapor deposition, the uniformity, controllability, and reproducibility of the thickness of the film are good, a deposition rate is relatively low, and the stability between batches is good, which is suitable for large-scale automatic production.

The conductive portions (13 and 14) include a first electrode 13 and a second electrode 14 arranged on the base body 11, and the first electrode 13 and the second electrode 14 are both electrically connected to the infrared electric heating film 12, to feed electric power of a power supply to the infrared electric heating film 12. Specifically, after the electric power of the power supply is received, a current may flow from the first electrode 13 to the second electrode 14 through the infrared electric heating film 12.

In this example, the first electrode 13 and the second electrode 14 are both conductive coatings coated on end portions of the base body 11 through impregnation, and a material of the conductive coating is selected from at least one of silver, gold, palladium, platinum, copper, nickel, molybdenum, tungsten, or niobium. In other examples, the first electrode 13 and the second electrode 14 may also be conductive members sleeved on positions close to a first end and a second end of the base body 1, and the conductive member includes, but not limited to, a metal conductive sheet such as a copper sheet or a steel sheet.

In this example, the first electrode 13 and the second electrode 14 are annular. Further, the first electrode 13 and/or the second electrode 14 may further include a strip-shaped conductive coating part extending from the annular conductive coating part along an axial direction of the base body 11.

It should be noted that, the number of the conductive portions (13 and 14) is not limited to the situation shown in FIG. 1, and for example, an electrode may be further arranged between the first electrode 13 and the second electrode 14, to divide the infrared electric heating film 12 along the longitudinal direction of the base body 11 into a first partial infrared electric heating film 12 and a second partial infrared electric heating film 12, and electric power fed to the first partial infrared electric heating film 12 and/or the second partial infrared electric heating film 12 are controlled independently to control to heat different positions of the base body 11, thereby performing segmented heating on the aerosol-forming substrate. Through the segmented heating, the heating speed of the aerosol-generation substrate, the consistency of fragrance volatilization, and the inhalation taste may be ensured.

Implementation 2:

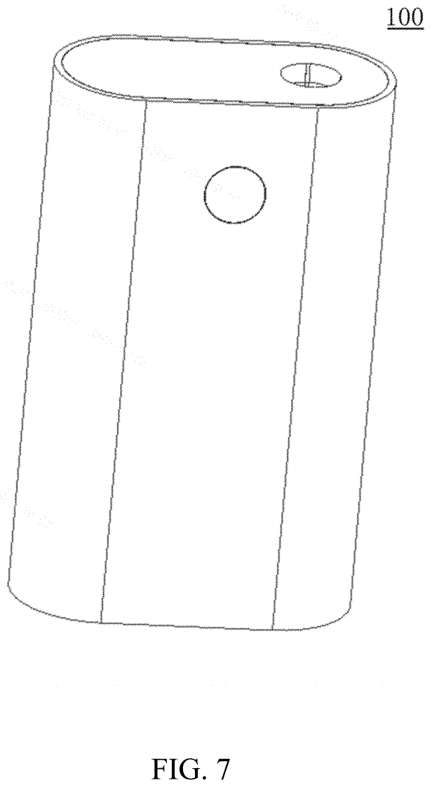

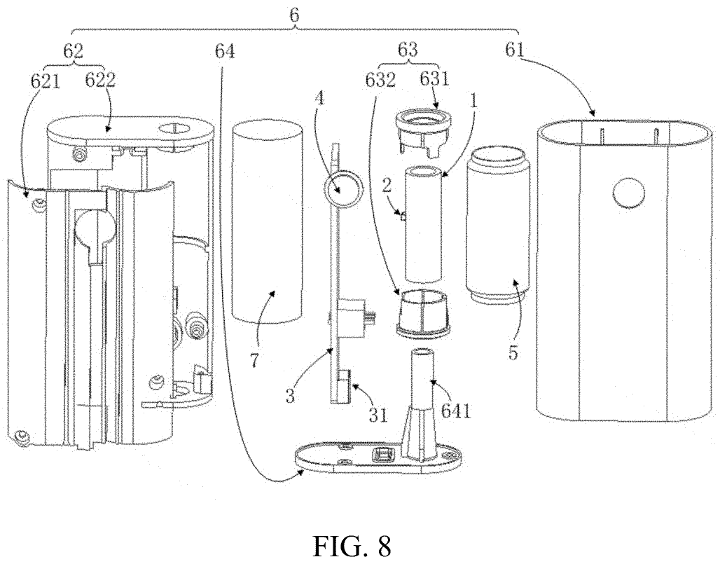

FIG. 7 and FIG. 8 are an aerosol-generation device 100 provided according to Implementation 2 of this application, which includes a housing assembly 6 and a heater 1. For a structure of the heater 1, reference may be made to the content of Implementation 1, and repeated parts are not described herein again.

The heater 1 is arranged in the housing assembly 6. The aerosol-generation device 100 in this embodiment includes a base body 11, an infrared electric heating film 12 formed on an outer surface of the base body 11, and conductive portions (13 and 14) formed on two ends of the base body 11. The infrared electric heating film 12 receives the electric power of the power supply through the conductive portions (13 and 14) to generate heat, so that the infrared electric heating film 12 is heated up by the heat and generates infrared ray, and the infrared electric heating film 12 performs radiation heating on an aerosol-forming substrate in a chamber of the base body 11.

The housing assembly 6 includes a shell 61, a fixing shell 62, a fixing member 63, and a bottom cap 64, and both the fixing shell 62 and the fixing member 63 are fixed in the shell 61, where the fixing member 63 is configured to fix the base body 11, the fixing member 63 is arranged in the fixing shell 62, and the bottom cap 64 is arranged on one end of the shell 61 and covers the shell 61. Specifically, the fixing member 63 includes an upper fixing base 631 and a lower fixing base 632, both the upper fixing base 631 and the lower fixing base 632 are arranged in the fixing shell 62, and a first end and a second end of the base body 11 are respectively fixed onto the upper fixing base 631 and the lower fixing base 632. An air inlet tube 641 protrudes from the bottom cap 64, one end of the lower fixing base 632 away from the upper fixing base 631 is connected to the air inlet tube 641, and the upper fixing base 631, the base body 1, the lower fixing base 632, and the air inlet tube 641 are coaxially arranged. The base body 11 and the upper fixing base 631 as well as the lower fixing base 632 are sealed, the lower fixing base 632 and the air inlet tube 641 are also sealed, and the air inlet tube 641 is in communication with external air to facilitate smooth air intaking during inhalation by a user.

The aerosol-generation device 100 further includes a control circuit board 3 and a battery 7. The fixing shell 62 includes a front shell 621 and a rear shell 622, the front shell 621 is fixedly connected to the rear shell 622, the control circuit board 3 and the battery 7 are arranged in the fixing shell 62, and the battery 7 is electrically connected to the control circuit board 3. A button 4 protrudes from the shell 61, and turn-on or turn-off of the infrared electric heating film 12 on the surface of the base body 11 may be implemented by pressing the button 4. The control circuit board 3 is further connected to a charging interface 31, the charging interface 31 is exposed on the bottom cap 64, and the user may charge or upgrade the aerosol-generation device 100 through the charging interface 31, to ensure continuous use of the aerosol-generation device 100.

The aerosol-generation device 100 further includes a heat insulation tube 5, the heat insulation tube 5 is arranged in the fixing shell 62, and the heat insulation tube 5 is sleeved on the periphery of the base body 11, to at least partially prevent heat conduction from the heater 1 to the housing assembly 6, where the heat conduction causes the user to feel burnt. The heat insulation tube may include a heat insulation material, and the heat insulation material may be heat insulation glue, aerogel, aerogel felt, asbestos, aluminum silicate, calcium silicate, diatomite, or zirconium oxide. The heat insulation tube 5 may be a vacuum heat insulation tube. An infrared ray reflective coating may be further coated on an inner surface of the heat insulation tube 5, to reflect the infrared ray radiated by the infrared electric heating film 12 to the base body 11, thereby improving the heating efficiency.

The aerosol-generation device 100 further includes a temperature sensor 2 such as an NTC temperature sensor. The temperature sensor 2 is configured to detect a real-time temperature of the base body 11 and transmit the detected real-time temperature to the control circuit board 3, and the control circuit board 3 adjusts a magnitude of a current flowing on the infrared electric heating film 12 according to the real-time temperature.

Specifically, when the temperature sensor 2 detects that the real-time temperature in the base body 11 is relatively low, for example, detects that a temperature on an inner side of the base body 11 does not reach 150° C., the control circuit board 3 controls the battery 7 to output a relatively high voltage to the conductive portions (13 and 14), to further improve a current fed into the infrared electric heating film 12, improve the heating power to the aerosol-forming substrate, and reduce a time for which the user needs to wait before inhalation is performed.

When the temperature sensor 2 detects that the temperature of the base body 11 ranges from 150° C. to 200° C., the control circuit board 3 controls the battery 7 to output a normal voltage to the conductive portions (13 and 14).

When the temperature sensor 2 detects that the temperature of the base body 11 ranges from 200° C. to 250° C., the control circuit board 3 controls the battery 7 to output a relatively low voltage to the conductive portions (13 and 14).

When the temperature sensor 2 detects that the temperature on the inner side of the base body 11 is 250° C. or higher, the control circuit board 3 controls the battery 7 to stop outputting a voltage to the conductive portions (13 and 14).

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features may further be combined to form various embodiments not listed above, and all such embodiments shall be construed as falling within the scope of the specification of this application. Further, a person of ordinary skill in the art may make improvements and variations according to the above descriptions, and such improvements and variations shall all fall within the protection scope of the appended claims of this application.

1. A heater, configured to heat an aerosol-forming substrate to volatilize at least one component in the aerosol-forming substrate, and the heater comprising:
a base body;
an infrared electric heating film, formed on a surface of the base body, the infrared electric heating film comprising doped tin oxide and doping elements of the doped tin oxide comprising non-metal elements; and the infrared electric heating film being configured to generate infrared ray and heat the aerosol-forming substrate at least in a radiation manner; and
a conductive portion, comprising a first electrode and a second electrode arranged on the base body, and both the first electrode and the second electrode being electrically connected to the infrared electric heating film to feed electric power of a power supply to the infrared electric heating film.

2. The heater according to claim 1, wherein the non-metal elements comprise phosphorus.

3. The heater according to claim 2, wherein an atomic percentage of the phosphorus ranges from 5% to 9%, preferably ranges from 5% to 8.7%, and more preferably ranges from 6% to 8.7%.

4. The heater according to claim 1, wherein the non-metal elements further comprise carbon.

5. The heater according to claim 4, wherein an atomic percentage of the carbon ranges from 4% to 15%, preferably ranges from 4% to 14.7%, and more preferably ranges from 4.5% to 14.7%.

6. The heater according to claim 4, wherein the doping elements further comprise calcium.

7. The heater according to claim 6, wherein an atomic percentage of the calcium ranges from 1% to 2%, preferably ranges from 1.2% to 1.8%, more preferably ranges from 1.2% to 1.6%, and further preferably is 1.4%.

8. The heater according to claim 1, wherein a thickness of the infrared electric heating film ranges from 100 nm to 30 μm, preferably ranges from 300 nm to 3 μm, more preferably ranges from 500 nm to 2 μm, and further preferably ranges from 800 nm to 1 μm.

9. The heater according to claim 1, wherein a sheet resistance (Ω/puff) of the infrared electric heating film ranges from 0.3 to 35, preferably ranges from 1 to 30, more preferably ranges from 1 to 18, further preferably ranges from 1 to 14, further preferably ranges from 1 to 10, further preferably ranges from 1.5 to 10, further preferably ranges from 2 to 10, further preferably ranges from 3 to 10, and further preferably ranges from 3.5 to 10.

10. The heater according to claim 1, wherein the infrared electric heating film is formed on the base body by a physical vapor deposition process or a chemical vapor deposition process.

11. The heater according to claim 1, wherein the first electrode and/or the second electrode comprise at least one of the following:
a conductive coating formed on the base body; and
a conductive member sleeved on the base body.

12. The heater according to claim 1, wherein a material of the base body is selected from at least one of monocrystalline germanium, monocrystalline silicon, gallium arsenide, gallium phosphide, sapphire, polycrystalline aluminum oxide, spinel, magnesium oxide, Yttrium(III) oxide, quartz, yttrium aluminum garnet, zinc sulphur, zinc selenide, silicon carbide, silicon nitride, magnesium fluoride, calcium fluoride, or arsenic trisulfide.

13. An aerosol-generation device, comprising a housing assembly and the heater according to claim 1, wherein the heater is arranged in the housing assembly.

14. The heater according to claim 2, wherein the non-metal elements further comprise carbon.

15. The heater according to claim 14, wherein an atomic percentage of the carbon ranges from 4% to 15%, preferably ranges from 4% to 14.7%, and more preferably ranges from 4.5% to 14.7%.

16. The heater according to claim 14, wherein the doping elements further comprise calcium.

17. The heater according to claim 16, wherein an atomic percentage of the calcium ranges from 1% to 2%, preferably ranges from 1.2% to 1.8%, more preferably ranges from 1.2% to 1.6%, and further preferably is 1.4%.

18. The heater according to claim 5, wherein the doping elements further comprise calcium.

19. The heater according to claim 18, wherein an atomic percentage of the calcium ranges from 1% to 2%, preferably ranges from 1.2% to 1.8%, more preferably ranges from 1.2% to 1.6%, and further preferably is 1.4%.
